(19) United States
(12) Patent Application Publication
(10) Pub. No.: US 2006/0014125 A1
(43) Pub. Date: Jan. 19, 2006

(54) Walking through walls training system

(76) Inventor: John Quincy St. Clair, San Juan, PR (US)

Correspondence Address: JOHN ST. CLAIR;4A, 52 KINGS COURT, SAN JUAN, PR, 00911, US

(21) Appl. No.: 10/890,635

(22) Filed: Jul. 14, 2004

(51) Int. Cl. G09B 19/00

(52) U.S. Cl. 434/258

(57) ABSTRACT

This invention is a training system which enables a human being to acquire sufficient hyperspace energy in order to pull the body out of dimension so that the person can walk through solid objects such as wooden doors.

### BRIEF SUMMARY OF THE INVENTION

This invention is a training system that enables a human being to acquire sufficient hyperspace energy in order to pull the body out of dimension so that the person can walk through solid objects such as wooden doors.

### BACKGROUND OF THE INVENTION

A human being is a hyperspace energy being living in a physical container or body that is comprised of 67% water. This high percentage of water makes this invention possible. Referring to FIG. 1, the hyperspace energy being receives energy from our dimension through seven vortices that run the length of the body. Each vortex connects to a separate hyperspace dimension having its own particular frequency. This arrangement allows for the development of seven modular energy components corresponding to the mind, spiritual eye, voice, body, abdomen, plasma energy ball (battery), and ground connection.

Vortex (A), known as the top vortex, supplies energy to the mind and provides a channel of communication to other entities in the universe. This channel has been tested up to 100,000 light years which is the diameter of the galaxy.

Vortex (B), known as the spiritual eye, has a hollow cone-like appearance surrounded by white, misty, low-density hyperspace energy. Because the eye is modular, the mind can project it to vast distances, a process known as remote viewing.

Vortex (C), known as the voice and hearing module, can also be projected to enormous distances in order to communicate verbally with other entities. Using the proper remote viewing instruments, it is possible to project both the eye and verbal modules to see and talk at the same time.

Vortex (D), known as the heart vortex, provides protective energy to the upper internal organs, arms and hands.

Vortex (E) provides protective energy for the lower organs such as the intestines, liver and kidneys.

Vortex (F), known as the battery of the body, consists of an orange-colored plasma energy ball about one to two inches in diameter. The body becomes paralyzed if this ball is removed from the body. When the hyperspace energy being leaves the body, the vortices close and the battery takes over in order to keep the body functioning. This vortex also plays a role in the creation of the astral energy baby that attaches to the fertilized egg.

Vortex (G) is the ground vortex which rotates in the counter-clockwise direction in order to provide an energy ground for the electrical circuit. All the other vortices rotate in the clockwise direction as seen from the front such that energy flows into the vortex according to the right-hand rule of physics.

Vortex (H) is the hand vortex which rotates counterclockwise on the right hand and clockwise on the left hand as seen looking at the palm. Thus there is a rotating flow of hyperspace energy between the two hands when the palms are facing each other.

Referring to FIG. 2, each vortex feeds energy into its own hyperspace module shown by the lettered box. In terms of quantum mechanics, each box is actually a potential energy well in which each module develops separately. At the time of death of the body, these modules are joined together as a single energy being. The process is powered by the plasma energy ball battery which also contains the logical instructions for assembly.

Different people, as tested by the pendulum on the hand vortex, have different vortex sizes. Three people were tested. The first person had almost no rotational movement showing very little energy. The second person had a vortex radius of one inch. Another had a vortex radius of four inches which covered his entire hand. The latter also has the ability to lift another human being, lying prone on a table, off the table by flowing low-density hyperspace energy into the person through the hand vortices. He has also experienced walking through a solid wooden door with a dog at his side. What this means is that there is a way, as described in this invention, of creating large energy vortices which will enable a person to acquire sufficient energy to walk out of dimension through solid objects such as wooden doors.

Researching the historical records, referring to the statue in FIG. 3, a humble black Catholic Dominican friar of the Santo Rosario Convent, by the name of San Martin de Porres, living in Peru in the 1500's, also developed this ability to walk through doors. For his beatification, many witnesses came forward to recount his extraordinary abilities. For example, a witness, who worked in the Convent, went to the cell of San Martin to ask for something to eat. When he reached the cell, he saw San Martin leaving with some medications apparently to heal someone sick. The witness waited by the open door of the cell for his return. After having waited awhile without being distracted by anything else, he saw said venerable brother fray Martin come out from his cell from the inside and call him by name. The witness was terrified, not understanding how this was possible.

The woman who gave me the statue told me that he would walk miles and miles each day to visit the poor. The task of walking means that there is a velocity involved. Because the body has mass, then there is a mass times a velocity, or momentum, involved in this ability. Notice also that the statue shows him walking with his right arm crossed over his left arm in the form of an X.

What this walking momentum means in terms of physics is given in the following analysis. The human body consists of 67% water. A water molecule consists of two hydrogen atoms and one oxygen atom having the atomic formula H₂O. The atomic weight of one atom of hydrogen is 1.008 awu. The atomic weight of one atom of oxygen is 16.000 awu. The molecular weight of one atom of water is therefore:

| | |
|---|---|
| Weight of two atoms of hydrogen 2 × 1.008 awu = | 2.016 awu |
| Weight of one atom of oxygen 1 × 16.000 awu = | 16.000 awu |
| | 18.016 awu |

The formula weight is just the atomic weight expressed in grams. Thus the formula weight of water would be 18.016 grams or 0.018016 kilograms. According to Avogadro's law, the formula weight contains N=6.02×10²³ molecules. Thus the mass of one water molecule is the formula weight divided by the number of molecules:

$$mass = \frac{.018016 kg}{N} = 2.99269103 \cdot {10}^{- 26} kg$$

$$ln ( \frac{mass}{1 kg} ) = - 58.77103943$$

According to Einstein's Special Theory of Relativity, energy is equal to the mass times the speed of light squared. The energy of a photon is equal to Planck's constant h times the frequency f of the photon. Equating these two energies shows that

$$E = {mc}^{2} = hf = h \frac{c}{λ} = \frac{h}{c} \frac{{c}^{2}}{λ} \\ ⇒ m λ = \frac{h}{c} \\ ⇒ ln ( m ) + ln ( λ ) = ln ( \frac{h}{c} ) = base = - 95.91546344$$

which says that the natural logarithm of the mass plus the natural logarithm of the wavelength is equal to the natural logarithm of Planck's constant divided by the speed of light c, known as the base constant in the tetrahedron diagram. This diagram plots the mass versus wavelength in natural logarithms. Notice that the left hand side of the equation is the sum of mass and wavelength, so the right hand side must also be the same.

$$ln ( \frac{h}{c} ) = ln ( \frac{ΩΛ 2 πΛ c}{c} ) = ln ( ΩΛ ) + ln ( 2 πΛ )$$

where ΩΛ, known as the Planck mass, is the linear mass Ω of the universe times the bottom dimensional limit of the universe Λ, and 2πΛ is the bottom dimensional wavelength, known as the Planck wavelength. That is, our dimension is bounded by the Planck box having sides Planck mass and Planck wavelength. These boundaries have values:
ln(ΩΛ)=−17.64290101
ln(2πΛ)=−78.27256243

Referring to FIG. 4, these two lines are plotted on the tetrahedron diagram. The Planck mass line (A) reflects off the sphere (C) and returns as the Planck wavelength (B) which shows the dual nature of quantum physics. This creates the Planck box (a,b,c,d) which is the boundary of our dimension.

Referring to FIG. 5, the mass of the water molecule is plotted as horizontal line (D) on the diagram. The energy of the water molecule is the mass times the speed of light squared.
E=mc²
ln(c)=19.51860099
ln(mc²)=ln(m)+2 ln(c)

Referring to FIG. 6, a circle (E), having a radius equal to the speed of light squared, centered on the mass of the water molecule at the vertical axis, generates a circle (F), centered at the origin, that intersects (e) the mass of the water molecule at the Planck wavelength. That is, this intersection point sits right on the Planck box boundary between space and hyperspace. The radius of circle (F) is actually the mass of the water molecule divided by the speed of light squared.

$$E = \frac{m}{{c}^{2}} = m \\ ⇒ \frac{1}{{c}^{2}} = 1 \\ ⇒ c = 1 \frac{meter}{sec}$$

$$ln ( c ) = 0$$

Taking the positive square root, the speed of light is one meter per second at the Planck boundary. The experiments with brain hemisphere resonance show that the resonant frequency of the human energy field is between 1 Hz to 5 Hz which is well below the hearing threshold of 20 Hz. Because the traveling wave has a wavelength of 0.3048 m and the speed of light is unity at the boundary, the frequency should be

$$f = \frac{c}{λ} = \frac{1 \frac{m}{sec}}{.3048 m} = 3.28 Hz$$

which is within the middle of the experimental male range. At this resonant frequency, the human energy being pops out of the body. This represents only a first stage in the development of the energy being. But what is really wanted is to have both the physical body and the energy field move out of dimension together as San Martin did.

Referring to FIG. 7, the 45° base line (G) is added to the diagram. Notice that the Planck mass intersects (b,d) the Planck wavelength on this line because they sum to the base constant. The mass of the water molecule crosses this line at point (f). A circle, centered (f), with a radius equal to the speed of light, is tangent to the Planck wavelength (h) and the Planck mass (g). Since mass times velocity is momentum, the diagram says that the momentum of the water molecule is tangent to the boundaries of the Planck box which separates space from hyperspace. In order to get to point (e) from the momentum of the water molecule, a second circle is added to the momentum.

Referring to FIG. 8, a circle (I), centered on the water molecule mass at the speed of light circle (i), is made tangent to the Planck wavelength at point (e). The momentum M of space is equal to the Planck mass times the Planck scale times the speed of light. At point (e), the speed of light is unity, so that the momentum is just the Planck mass in momentum units:

$$M = ΩΛc = 2.176634194 \cdot {10}^{- 8} kg \frac{m}{s}$$

Circle (I) has a radius equal to
ratio=e^{21.572952}=2338912700
Therefore the walking momentum in order to get to point (e) is the momentum of space M times this ratio

$${M}_{w} = M \cdot ratio = 50.909573606 kg \frac{m}{sec}$$

The stride length L per second that a person of mass W has to walk is the walking momentum divided by the mass W times a period T of one second

$$L = \frac{{M}_{w}}{W} T$$

For a person with a mass W of 99.79 kg (220 pounds), then the stride length L is 20.08 inches or one foot and eight inches. The person has to walk this length in one second on each foot.

Looking at the statue of San Martin, his arms are crossed over each other. The vortex of the right hand points backward, and the left hand vortex points forward due to the reversed rotation. Referring to FIG. 9, this creates a rotational energy channel (D) around his body (A). The stride length (C) is calculated according to the body mass, and then a banner printout is made showing where the footprints (B) are to be placed each second. The question is: “What happens when one walks the walk?”.

On the very first experiment, referring to FIG. 10, what happens is that, after taking only six strides on the banner printout (A), a huge spinning vortex (C) develops over the top of the head and the vertex locks onto the heart vortex in the center of the chest (B). In everyday life, this vortex is not created because normal walking is much faster and the hands are held at the side of the body. The energy rush through the pineal gland is so intense that one feels immediately sleepy and starts yawning excessively due to the increased flow of melatonin.

After practicing with the banner printout, long walks were made through the park. In this case, a vertical white line rotated around a vertical axis located about six feet perpendicular to the path on the right side of the body. When the walking speed was correct, this white line would lock onto the centerline of the body. Speeding up or down caused the white line to lose synchronization and rotate away. This white line is related to the ability to levitate the body. San Martin had so much energy that, according to witness testimony, he could float horizontally in the air with his head resting against the bowed head of Christ on a carved wooden cross. Thus San Martin's energy sources were channeling energy from Christ, collective broom energy as described in a separate patent application, and the walking momentum vortex energy.

During the early part of the 20th century, a man's parents were lying in bed dying of tuberculosis. With their permission, he placed a weighing scale under each of their beds. When they passed away, he found that each scale registered a loss in weight of 2.5 ounces. This is equivalent to 0.071 kg, which is the mass of the human energy being.

After conducting a number of experiments with water vortices draining from a cylindrical tank, it can be stated from Bernoulli's theorem that the potential energy plus the kinetic energy is a constant

$$gz + \frac{1}{2} {mv}^{2} = const$$

The shape of the inner surface of the water circulation has a velocity proportional to the inverse of the radius, so the shape of the surface is

$$( z - {z}_{0} ) = \frac{k}{{r}^{2}}$$

which says that the height of the vortex is proportional to the inverse of the square of the radius.

The hand vortex area ratio between the second test subject and the third test subject is equal to the square of their radii:

$$ratio = \frac{{( 1 in )}^{2}}{{( 4 in )}^{2}} = \frac{1}{16}$$

Because the speed of light at the boundary was determined to be one meter per second, the energy of the third test subject is

$$E = ( \frac{.071 kg}{16} ) {( \frac{1 m}{sec} )}^{2} = 4.4375 \cdot {10}^{- 3} joule$$

$$ln ( E ) = - 5.417664124$$

Referring to FIG. 11, a circle (K), having this radius, is added to the energy of the water molecule (E), to produce augmented energy circle (J). This circle (J) intersects the mass of the water molecule outside the Planck box at point (j). This means that the increased hyperspace energy moves the water molecule, and hence the body, out of dimension. Furthermore, circle (J) is tangent to the walking momentum ratio circle (I) which keeps the geometry locked together.

### SUMMARY OF THE INVENTION

It is the object of this invention to create a training system that allows a person to develop the ability to walk around out of dimension, passing through solid objects. This invention is based on one of the most remarkable relationships between the water molecule and the boundary between space and hyperspace. The mass of the water molecule is equal to the energy of the water molecule at this boundary. Because the body is composed of 67% water, the body sits on the boundary such that any additional increase in energy would move the body out of dimension into hyperspace. Because human beings are actually hyperspace energy beings living in physical bodies, the additional energy required to move the body out of dimension comes from increasing the energy of the hyperspace being. One source of this energy comes from walking cross-handed at the proper velocity in order to generate a large hyperspace energy vortex that flows energy into the potential wells of the hyperspace being. This increased hyperspace energy will then allow the person to walk around out of dimension through solid wooden doors. Because the door and the person are in two slightly different dimensions at the same moment, it appears that the person is walking through the door. After passing through the closed door, the person then returns to our dimension and emerges in the interior of the closed-door room.

This technique can be used in reverse to heal an infected hand instantaneously. A salve made from the St.Mary's herb is applied to the skin of the infected hand. The hyperspace energy then flows through the right-hand vortex such that the infected hand and the salve are taken slightly out of dimension. What happens is similar to when a short piece of straw is embedded in a hard wooden telephone pole as a tornado passes over the pole. The straw and pole are taken out of dimension such that they briefly merge together. As the tornado moves on, both objects come back to dimension merged together. Thus the salve (straw) is merged with the bacteria (pole) in hyperspace such that the bacteria is killed instantly. Removing the hand vortex brings the infected hand back into dimension cured.

Based on this information and the results of many experiments, this invention creates a large vortex by walking at a certain velocity with the hands crossed over the chest. The proper walking momentum is created by a computer program that inputs the person's weight, shoe length, and the number of strides to be taken. The program then prints out a banner showing the footprints where the person has to step each second. When a person obtains sufficient energy from these methods, the person is then tuned to the subspace geometry of the universe as will be shown using the tetrahedron physics diagram.

### A BRIEF DESCRIPTION OF THE DRAWINGS

FIG. 1. Energy vortices of the human body.

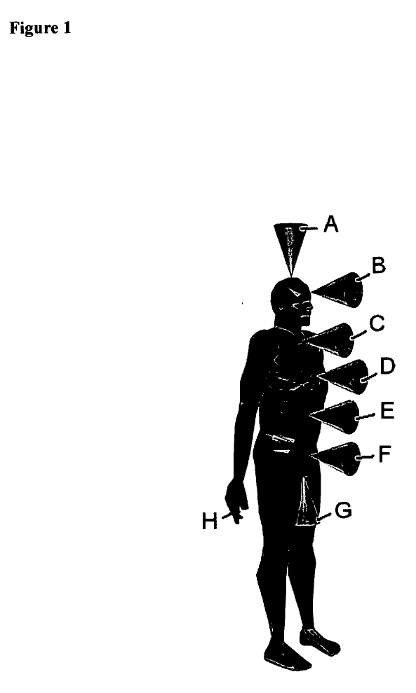

FIG. 2. Seven potential wells fed by the energy vortices of the body.

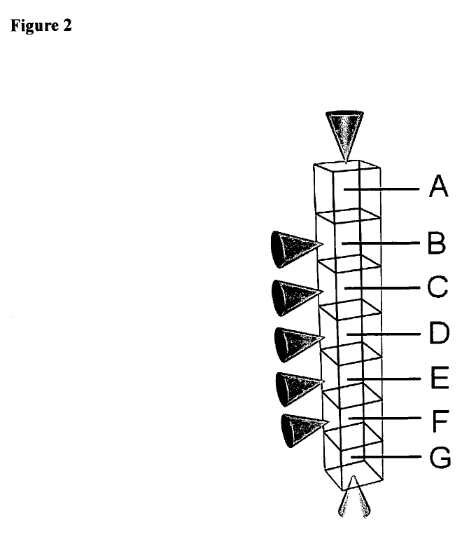

FIG. 3. Carved wooden statue of San Martin de Porres who could walk through solid wooden doors.

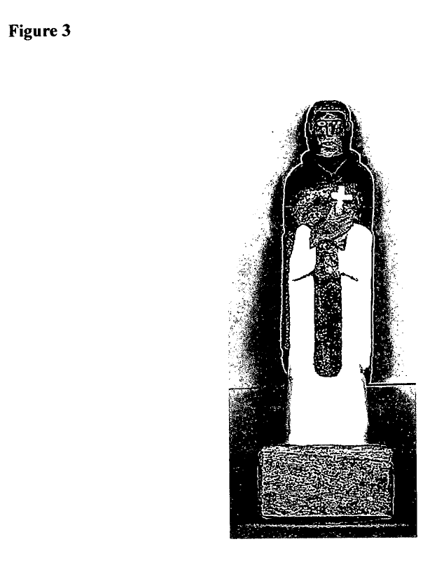

FIG. 4. Tetrahedron diagram showing boundaries of the Planck box of dimension.

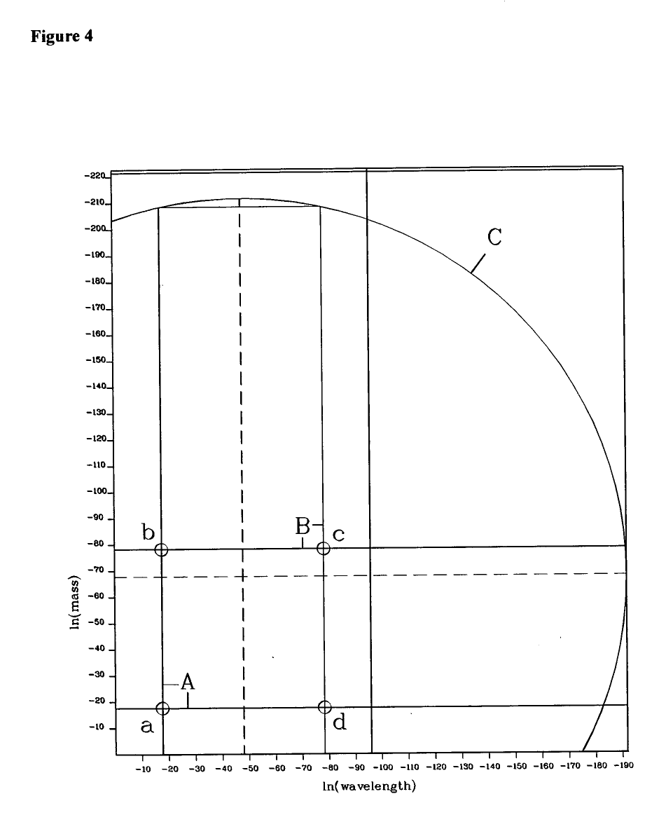

FIG. 5. Tetrahedron diagram showing mass of water molecule.

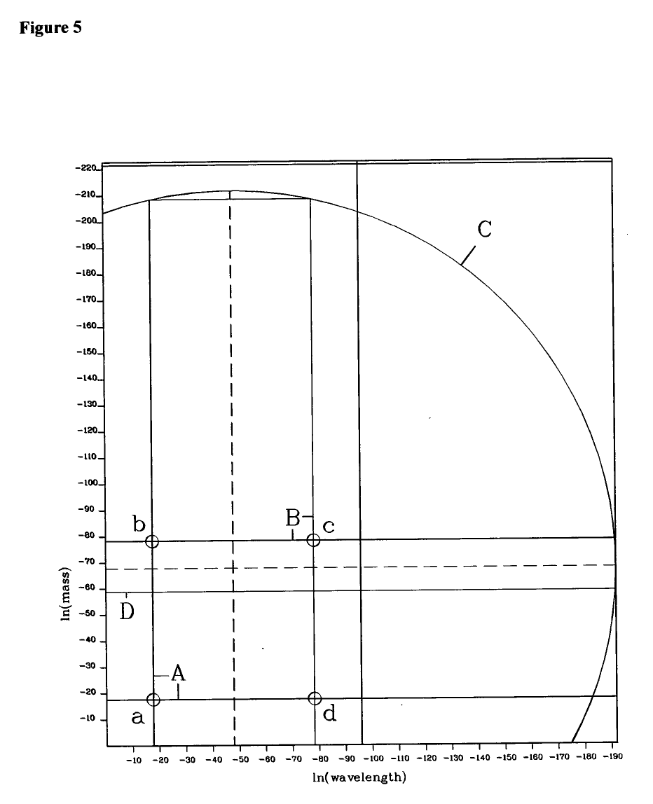

FIG. 6. Tetrahedron diagram showing water molecule energy and mass are equal at the Planck box boundary.

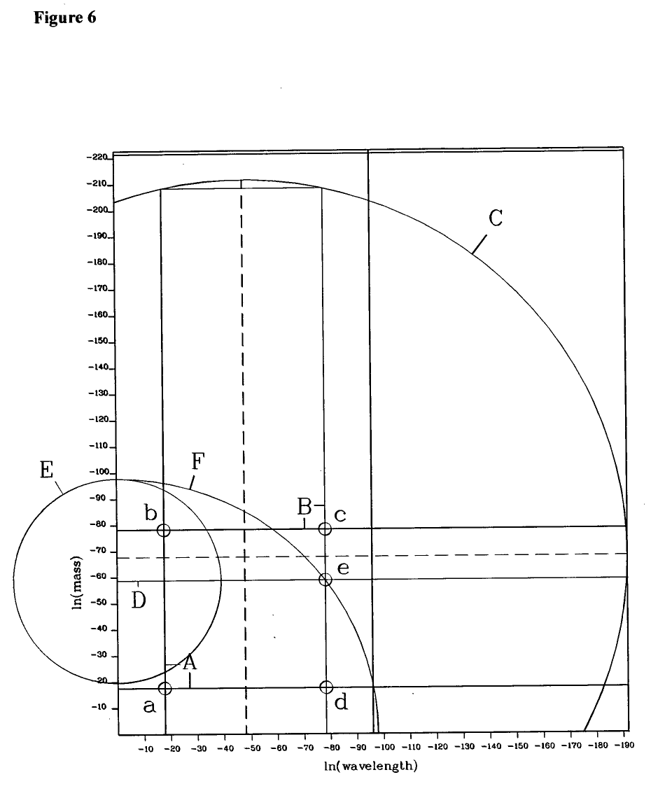

FIG. 7. Tetrahedron diagram showing that water molecule momentum is tangent to the boundaries of the Planck box.

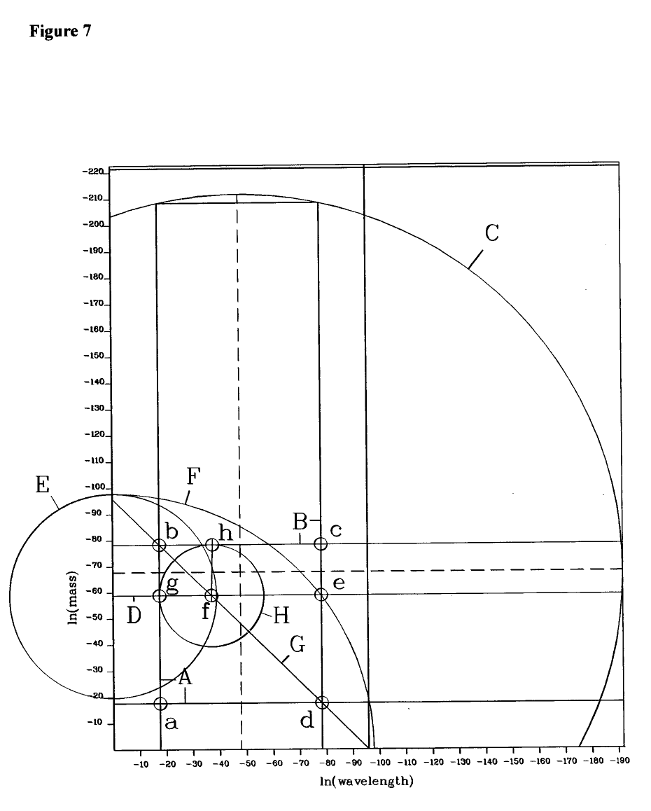

FIG. 8. Tetrahedron diagram showing the momentum ratio required to reach the Planck wavelength boundary from the water momentum.

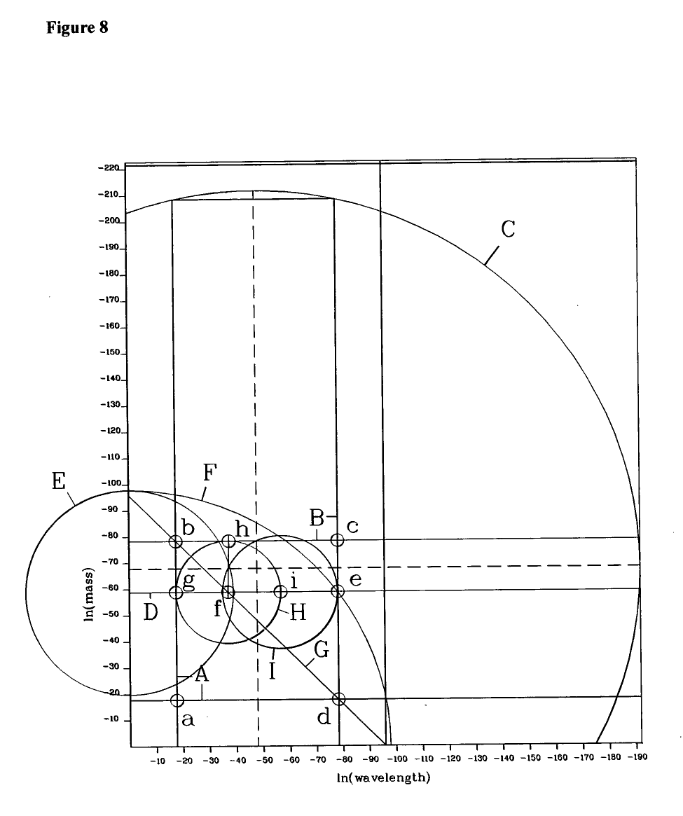

FIG. 9. Perspective view of crossed-hand momentum walking using banner printout.

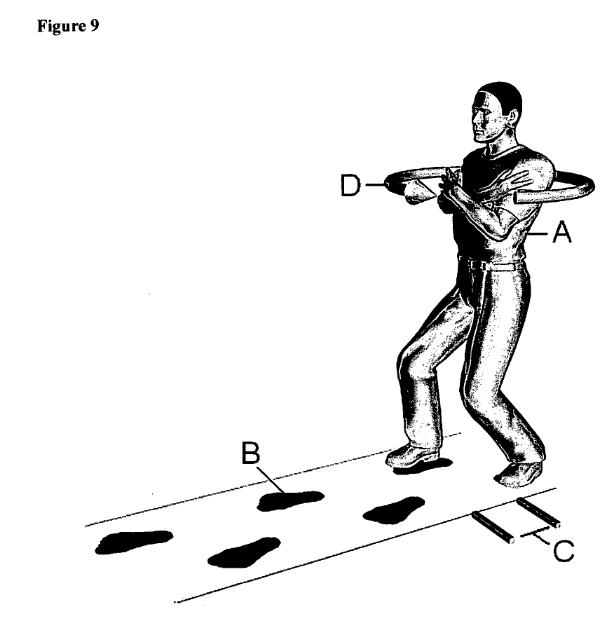

FIG. 10. Perspective view of vortex generated by momentum walking.

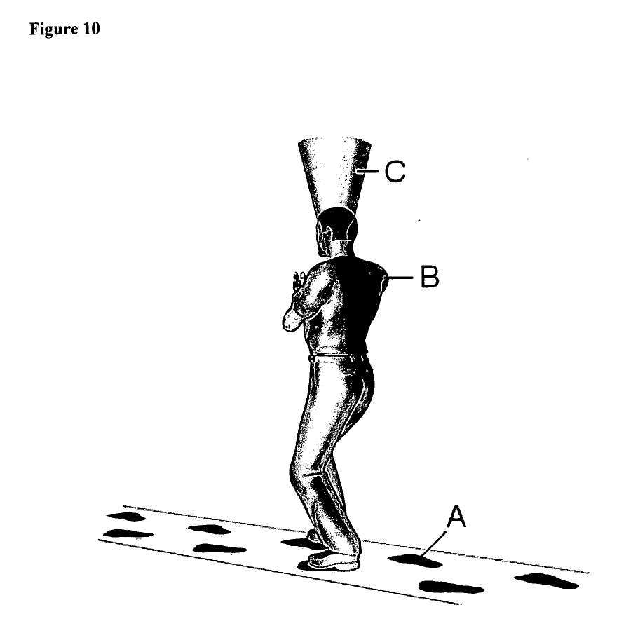

FIG. 11. Tetrahedron diagram showing how additional hyperspace energy supplied to the potential wells of the hyperspace energy being enables the human body to be pulled out of dimension.

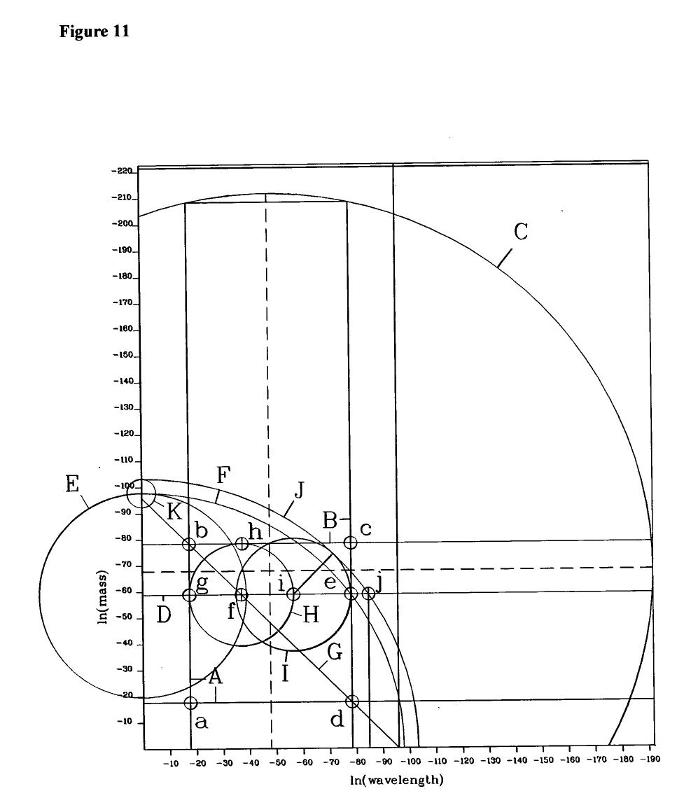

FIG. 12. Tetrahedron diagram showing the inverted tetrahedrons whose crossing represents the merging of two worlds between space and hyperspace.

FIG. 13. Tetrahedron diagram showing that the proton wavelength is determined by the Planck mass tangent to the inverted tetrahedrons.

FIG. 14. Tetrahedron diagram showing that the mass of the universe determines the electron and proton elementary particles.

FIG. 15. Tetrahedron diagram showing that momentum walking together with the increased energy of the hyperspace energy being is tangent to the mass of the universe.

FIG. 16. Computer program block diagram for printing banner footprints.

FIG. 17. Computer program input dialog window.

FIG. 18. Computer program calculation of stride length per second.

FIG. 19. Six-stride screen banner printout for 220 lb. person.

FIG. 20. Project tree showing help information by double clicking on node.

### DETAILED DESCRIPTION OF THE INVENTION

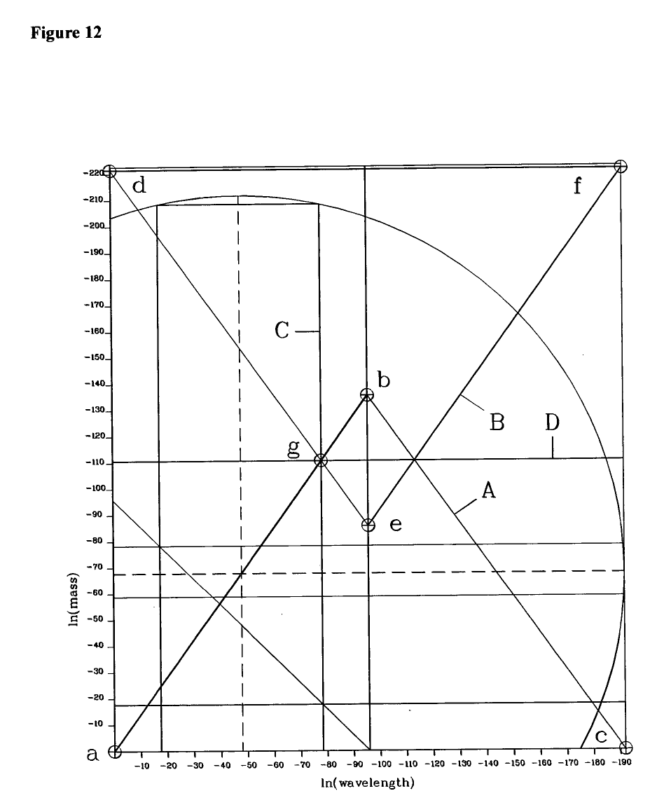

1. Referring to FIG. 12, a tetrahedron (A, path abc) is added to the diagram. The tip of the tetrahedron (e) falls on the base constant which is equal to Planck's constant divided by the speed of light. A second tetrahedron (B, path def) is inverted around horizontal line (D) which has a geometrical relationship to the base constant. The line is located at

$$centerline = \frac{2}{\sqrt{3}} ln ( \frac{h}{c} ) = - 110.7536373$$

Notice that the intersection of the two inverted tetrahedrons (g) occurs at the Planck wavelength which is the boundary between space and hyperspace. Line (D) is referred to as the merging of two worlds or the connecting of two worlds, a phrase obtained by means of remote viewing. That is, it is the dividing line between space and hyperspace. This is the reason that the two boundaries intersect at this point.

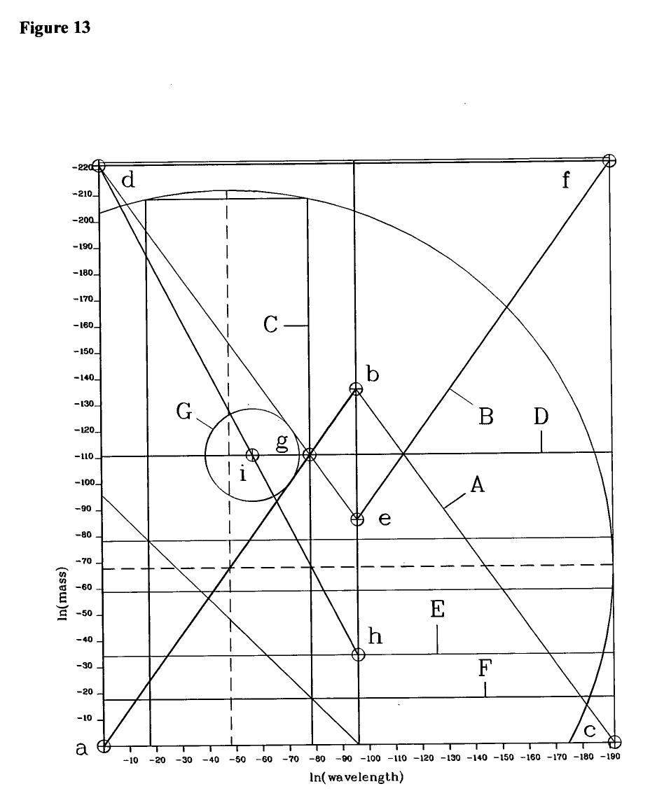

Referring to FIG. 13, the proton wavelength (E) is added to the diagram. The proton wavelength has a value of the electron wavelength divided by 1836.1527

$$ln ( {λ}_{p} ) = ln ( \frac{{λ}_{e}}{1836.1527} ) = - 34.26005901$$

A line (hd), from the base constant at the proton wavelength (h), to the corner of the inverted tetrahedron (d), intersects the merging of two worlds line at point (i). A circle, with a radius equal to the Planck mass (G), centered (i), is tangent to the inverted tetrahedrons. Thus the proton is defined by the base constant and the geometry of subspace. The reason that the proton is tangent to both tetrahedrons is because the electron and proton follow one single path between space and hyperspace. Thus there is only one single particle in nature. Because the particle enters our space at two different locations, we see the one particle as two distinct elementary particles. This relationship can be seen in Library of Congress tetrahedron diagram tet0565.

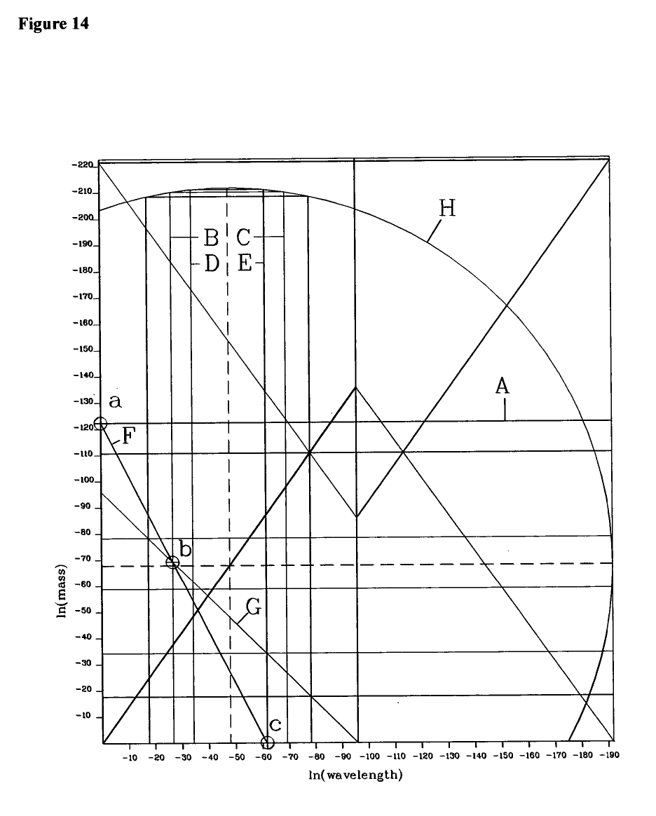

Referring to FIG. 14, the mass of the universe MU is equal to the linear mass Q of the universe times the radius R of the universe which is 10²⁶ meters
ln(MU)=ln(ΩR)=122.3347509
as shown on the diagram as line (A). The electron wavelength (B) reflects off the circumscribing sphere (H) and returns as the electron mass (C). The distance between reflection points is the hyperspace charge which is equal to the charge of space less the electron charge. So the electron goes from wavelength to electric charge to mass. The proton wavelength (D) reflects off the sphere and returns as the proton mass (E) which intersects the horizontal axis at point (c). A line (abc) from the mass of the universe at the vertical axis (a) to the proton at the horizontal axis (c) intersects the electron (b) which determines the electron's mass and wavelength since this point is on the 45° base line. What this means is that cosmology determines the values of the elementary particles.

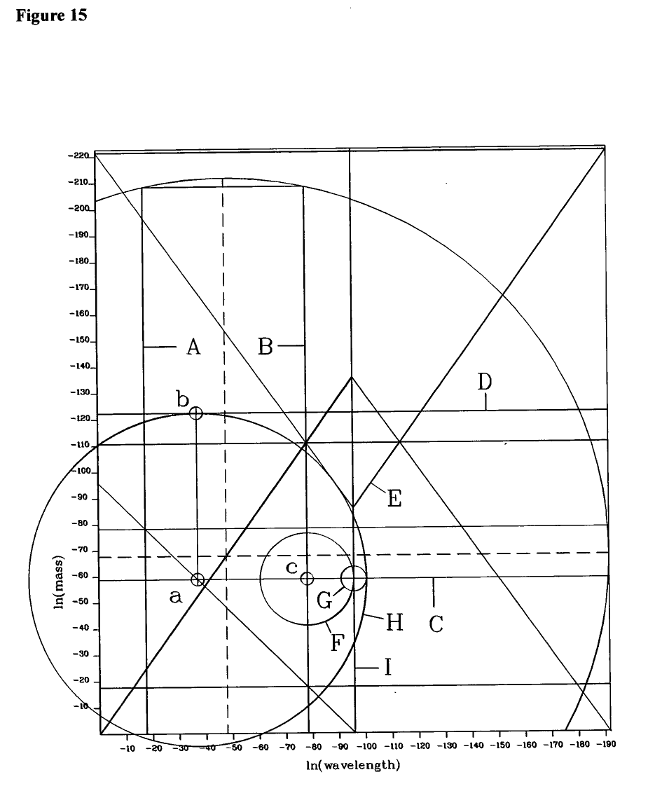

Referring to FIG. 15, the mass of the water molecule (C) intersects the 45° base line at point (a). A circle (F), with a radius equal to the Planck mass is centered on point (c) at the Planck wavelength boundary (B) where the mass of the water molecule numerically equals the energy of the water molecule and where the speed of light is unity. The Planck mass is tangent to the base constant which is the vertical centerline (I) of the diagram. The large circle (H), centered (a) on the water molecule, is tangent to the mass of the universe (b) and tangent to the inverted tetrahedron (E). The difference between this circle (H) and the base constant (I) is the energy the hyperspace being has to acquire in order to be tuned to the mass and geometry of subspace. This difference, shown as circle (G), has a mass
m=e^{-4.792671} kg=8.29·10⁻³ kg
Thus the hand vortex radius ratio has to be the square root of the mass of the hyperspace energy being divided by this tangent mass, or:

$$r = \sqrt{\frac{.071 kg \cdot 1 {in}^{2}}{{ⅇ}^{- 4.792671} kg}} \approx 3 inches$$

which is a vortex radius that is three times larger than that of a normal person, but one inch smaller than the third test subject who had a hand vortex radius of 4 inches. This is the reason that the third test subject was able to walk through walls and teleport to other locations because his energy was sufficiently large enough to cross over the inverted tetrahedron into a co-dimension of hyperspace. Notice also that dotted circle (J) with a radius equal to the mass of the water molecule, centered (c) on the boundary, is tangent to the tetrahedron (K). This makes the combined geometry tangent to the inverted tetrahedrons and the mass of the universe.

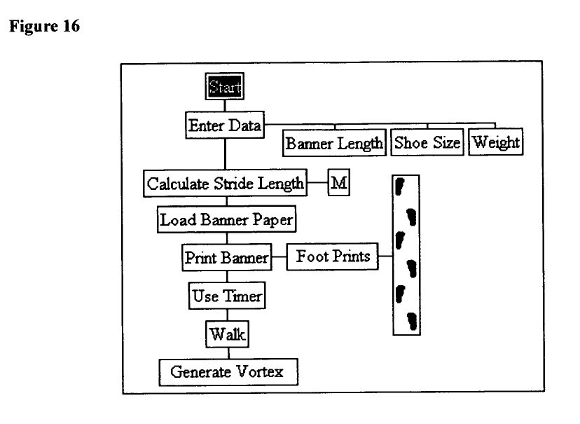

2. Referring to FIG. 16, a computer program generates a banner printout with footprints spaced for walking according to the weight, shoe size and length of banner desired. Some banners could fit in a small room, or be placed on the floor of a long corridor. As shown in the block diagram the program inputs these three variables with error checking. Then the program calculates the stride length L per second from the equation

$$L = \frac{M}{W} T$$

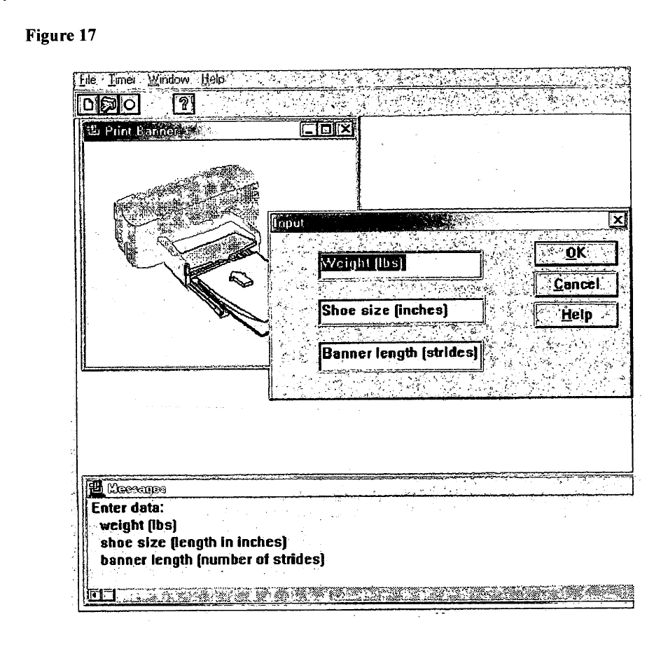

3. In the above equation, the value of the momentum M, as determined by the tetrahedron diagram, is preferably 50.9095736 kg m/s. The weight of the person is converted to mass W in kilograms. The stride period is preferably 1 second. Referring to FIG. 17, the data is entered in the dialog input window.

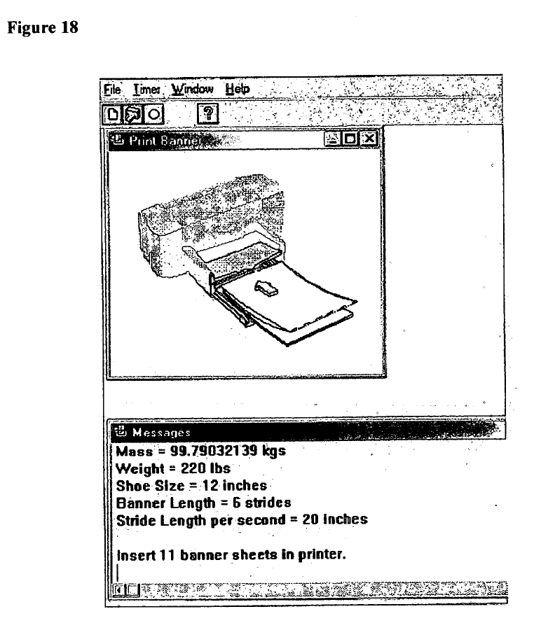

4. Once the stride length has been calculated, the program displays the stride length and the required number of banner sheets in the message window, as seen in FIG. 18.

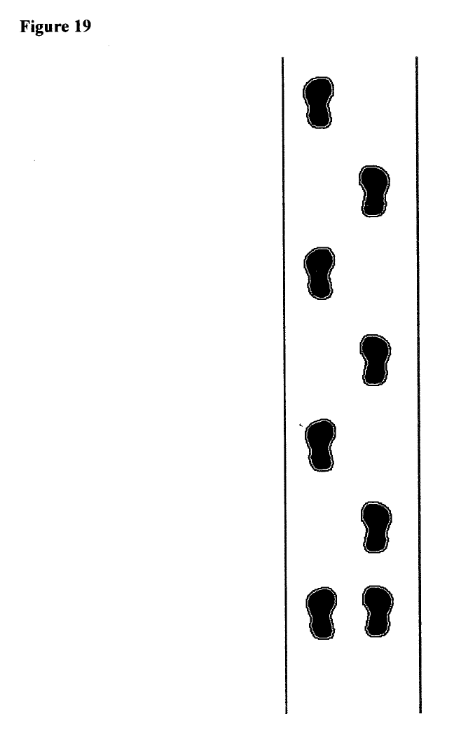

5. The print banner menu is selected and the foot prints are printed on continuous banner paper. A six-stride scaled screen version of the banner is shown in FIG. 19. The banner paper is then placed on the floor, and a one-second beeping timer is activated from the toolbar or menu. The person then walks beside the printed foot prints, taking one stride per beep, which produces the correct walking momentum to generate the hyperspace vortex. The vortex, which forms in only six strides, brings additional hyperspace energy into the quantum potential wells of the hyperspace energy being.

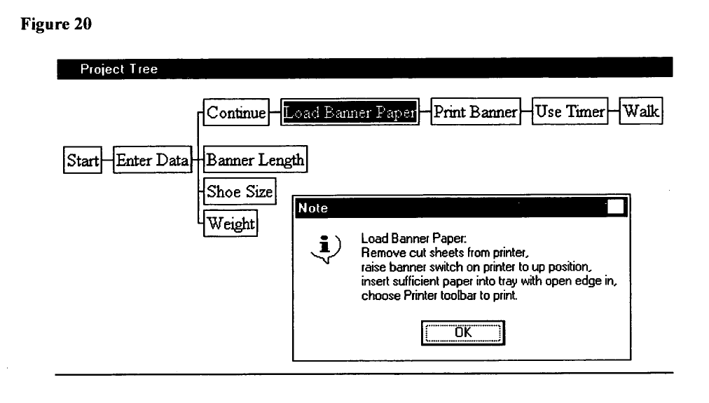

6. A help system consists of a project tree which explains the various steps in using the program. Double mouse clicking on a project tree node displays the help instructions in a dialog window as shown in FIG. 20.

7. In summary, the purpose of the training system is to substantially increase the energy of a human being who will then have the capability of walking through walls, body levitation, instantaneous healing of infections, full-body teleportation to another location, remote viewing at vast distances in terms of light-years, and looking into hyperspace co-dimensions. The third test subject and I have been able to experience all the above phenomena. He did it through augmenting his energy, and I have done it through the application of electromagnetic fields, by spinning on my vortex accelerator machine and using this invention.

I claim:

1. A training method comprising the steps of:
generating a banner having a plurality of footprints spaced at regular intervals wherein the banner is placed on the ground;
generating a periodic audible signal, whereby the audible signal repeats at a regular interval of time equal to the period; and
walking on the banner by tracing the footprints spaced at regular intervals, wherein one step is made with each audible signal.

2. The method of claim 1, wherein the step of generating the banner further comprises:
providing a person's actual mass in kilograms; and
determining the stride length based upon the following equation:
L=(M/W)*T
where L is the stride length in meters, M is a constant of approximately 50.91, W is the mass of the person in kilograms, and T is the period of the audible signal in seconds, and
wherein the footprints on the banner are spaced at the stride length.

3. The method of claim 2, wherein the audible signal is a beep and the period of the audible signal is one second.

4. A training method for a person comprising the steps of:
generating an audible signal having a fixed period;
generating a banner having regularly spaced indicia for identifying preferred step locations, wherein the distance between adjacent indicia is determined by the following formula:
L=(M/W)*T
where the distance between adjacent indicia in meters is L, a constant of 50.9095736 is equal to M, the person's mass in kilograms is W, and the fixed period in seconds is T; and
walking on the marked path by stepping upon each of the regularly spaced indicia wherein one step is made with each period of the audible signal.

5. The training method of claim 4 wherein the fixed period is one second.

6. The training method of claim 5, wherein the regularly spaced indicia are footprints.
